(19) United States
(12) Patent Application Publication
(10) Pub. No.: US 2003/0014398 A1
(43) Pub. Date: Jan. 16, 2003

(54) Query modification system for information retrieval

(75) Inventors: Yoshihiro Ohta, Tokyo (JP); Tetsuo Nishikawa, Tokyo (JP); Sigeo Ihara, Tokorozawa (JP)

Correspondence Address: Stanley P. Fisher, Reed Smith Hazel & Thomas LLP, Suite 1400, 3110 Fairview Park Drive, Falls Church, VA, 22042-4503, US

(73) Assignee: Hitachi, Ltd.

(21) Appl. No.: 10/076,400

(22) Filed: Feb. 19, 2002

(30) Foreign Application Priority Data
Jun. 29, 2001 (JP) 2001-198757

(51) Int. Cl. G06F 7/00

(52) U.S. Cl. 707/3

(57) ABSTRACT

Information demanded by a user can be provided more accurately and intelligibly. When query information is inputted to a text-format file name input form, a natural language input form, a UI number input form, a URL input form, a readout form for registered query conceptions or the like on a screen for generation of a query conception, a query conception assembled from the query information is represented on a screen as a query vector containing a plurality of keywords and weights of the respective keywords. A user can confirm the query conception by viewing the query vector and modify the query conception if necessary.

### BACKGROUND OF THE INVENTION

1. Field of the Invention

The present invention relates to information retrieval on the Internet. Specifically, the present invention relates to an information retrieval system and a server for retrieving documents in a field of bioscience, for example, and for representing information associated therewith.

2. Prior Art

Although research on information retrieval has a history of nearly half a century, a fundamental concept of the research has lied upon as how to distribute or collect academic information. Accordingly, retrieval objects in the information retrieval have been centered in homogeneous information in a closed world, such as books or treatises. On the contrary, the Internet which gained explosive popularity in 1990's has greatly impacted on the field of research on information retrieval. The information on the Internet is different from the information previously covered by the conventional research on information retrieval in terms of speeds of change, volumes, non-permanence, non-homogeneity, media diversity, openness and the like. In order to deal with the retrieval objects thus qualitatively different, modes previously used in the conventional information retrieval are not always adequate. A boost in the field of research on information retrieval in recent years is largely attributable to popularization of the Internet.

Retrieval services on the Internet, where more intellectual and higher-performance information retrieval systems are required, can be roughly categorized into a directory-type retrieval service such as “Yahoo! (http://www.yahoo.com/)” and a robot-type retrieval service such as “Alta Vista (http://www.altavista.com/)” or “Google (http://www.google.com/)”. The directory-type retrieval service adopts a mode of classifying URLs into fields by manpower; accordingly, the directory-type retrieval service has a characteristic of high reliability in indices and abstracts owing to production thereof by manpower, in contrast to a small data volume. Meanwhile, the robot-type retrieval service utilizes a WWW robot and a Web retrieval program called a spider for regularly collecting information on Web servers that can be found on the Internet, and performs indexing of the collected information. The robot-type retrieval service has an advantage of a large volume of information. Google, one of the robot-type retrieval services, does not apply only a conventional mode of information retrieval carried out by indexing texts and by calculating similarities, but also adds thereto a factor called a “page rank”, which is calculated based on link information concerning a certain page, thus enhancing performance as an information retrieval system.

Other various attempts are being introduced in addition to the above-mentioned conventional mode. In particular, a mode that is applicable only to a case in a limited field of resources on the Internet has been also developed. Such an approach is also attempted on PubMed (http://www.nebi.nlm.nih.gov/entrez/query.fcgi?db=PubMed), a document database by Nation Center for Biotechnology Information (NCBI) in the United States, which is a site for transmission of information in the field of bioscience. The attempt therein is to extract a document explaining most precisely on a gene based on the name of the gene that is given by a query, and to be capable of retrieving other documents of high similarity to the foregoing document. In the field of bioscience, along with development of a human genome project (a draft sequence was completed in July, 2000), relevant treatises are actually increasing day by day. In PubMed as well, a plurality of treatises are newly registered and renewed everyday. It is true that operations of extracting information appropriately for demands from every user out of retrieval objects in such a state are still difficult.

Here, information retrieval refers to finding a document out of a set of documents so as to conform to a query given by a user. A query refers to an incarnation of a demand for information that a user feels necessary for solving a problem. The query has a format that can be directly inputted to an information retrieval system. An information retrieval system is a group of systems for accepting a query from a user, finding a document conforming to the query out of a set of documents with a computer and submitting the document to the user. In the information retrieval system in the computer, the set of documents being a retrieval object as well as the query given by the user are converted into internal representations so as to be treated inside the computer. Thereafter, the computer executes retrieval by comparing the both. Processing for conversion of the set of documents being the retrieval object and the query inputted by the user into the internal representations, which can be treated inside the computer, is referred to as indexing. A basic concept of indexing is that a document is a group of sentences and a sentence is a group of words. A minimum unit in this event, such as a word, is called an index term. Based on the foregoing concept, each document dᵢ can be expressed as a vector shown in the following formula (1. 1) containing frequencies of occurrence wᵢⱼ of index terms tⱼ constituting the document dᵢ:

$$\begin{matrix}[ Formula 1 ] & \\ {d}_{i} = ( \begin{matrix}{w}_{i1} \\ {w}_{i2} \\ M \\ {w}_{i2} \\ M \\ {w}_{iM}\end{matrix} ) & Formula ( 1.1 )\end{matrix}$$

In general, the following steps of processing take place in indexing:

1) deleting stop words in a document with reference to a stop list;

2) stemming; and

3) weighting on index terms based on frequencies of words.

A main role of indexing is to extract full index terms characterizing such a document out of the document. Here, it is also possible to attach a scale to each index term as importance of the index term, which indicates how closely the extracted index term is related to the document. An act of providing an extracted index term with the scale indicating the importance thereof is referred to as weighting of an index term. The simplest aspect of weighting of an index term is a case of using a frequency itself indicating how often the index term is used in a document. When wᵢⱼ denotes frequencies of occurrence of index terms tⱼ constituting the document dᵢ, whereas each document can be perceived as the vector expressed by the formula (1. 1), conceived here is a matrix as shown in a formula (1. 2) below. Specifically, each row represents a distribution of an index term over documents, and each column represents a distribution of index terms in a document.

$$\begin{matrix}[ Formula 2 ] & \\ A = \begin{matrix}{t}_{1} \\ {t}_{2} \\ M \\ {t}_{N}\end{matrix} {[ \begin{matrix}{w}_{11} & {w}_{21} & Λ & {w}_{M1} \\ {w}_{12} & O & N & M \\ M & N & O & M \\ {w}_{1 N} & Λ & Λ & {w}_{MN}\end{matrix} ]}^{{d}_{1} {d}_{2} Λ {d}_{M}} & Formula ( 1.2 )\end{matrix}$$

As described above, it is efficient that a computer possesses a set of documents being the retrieval object in a form of a matrix, for subsequent comparison with a query, that is, in actual retrieval.

In the foregoing, description has been made regarding internal representations of documents being the retrieval object. Next, description will be made regarding an internal representation of a query inputted by a user. Input of a query herein is deemed as direct input of index terms. A set of index terms is converted into internal representations of a computer as similarly to the above-described retrieval object. Steps of processing, which are similar to the foregoing processing of the retrieval objects, are basically performed concerning the query as well. That is, the processing of stop words, stemming or weighting is performed. However, there is only one query in one operation of retrieval unlike the set of documents composed of multiple documents. Accordingly, a query q is not given as a matrix such as the formula (1. 2), but a query is given as a vector in the following formula (1. 3), wherein the vector contains frequencies of occurrence w_{qj} of index terms tⱼ as elements thereof:

$$\begin{matrix}[ Formula 3 ] & \\ q = ( \begin{matrix}{w}_{q1} \\ {w}_{q2} \\ M \\ {w}_{qj} \\ M \\ {w}_{qM}\end{matrix} ) & Formula ( 1.3 )\end{matrix}$$

So far, the set of documents being the retrieval object as well as the query inputted by a user have been severally converted into the internal representations of similar formats with index terms and frequencies thereof. Now, retrieval will take place by comparison between the documents and the query using the internal representations. Here, a variety of retrieval models has been proposed to date. Some typical examples thereof include a Boolean model, a vector space model, a probabilistic model, a fuzzy set model, an extended Boolean model, a network model and a cluster model.

The simplest of all the retrieval models for comparing documents with a query is the Boolean model. The Boolean model solely extracts documents containing an index term that is identical to an index term used in a query; accordingly, such extraction can be readily obtained by logical operations. Moreover, the Boolean model is deemed practical because technologies for speeding up of processing have been also contrived therefor. Nevertheless, in general, the Boolean model is often combined with another mode because the Boolean model cannot rank retrieval results (Takenobu Tokunaga: “Information Retrieval and Language Processing, Languages and Calculations 5”, University of Tokyo Press, 1999).

In the vector space model, which is a basic mode for a retrieval system to be taken up in this specification, each document is set up as a column vector taken out from the columns in the formula (1. 2), and measurement is made regarding similarity of the column vector to a query vector of the same dimension as expressed by the formula (1. 3). Such similarity effectuates ranking of the retrieval results. The similarity between vectors is often calculated by use of cosine thereof (a formula (1. 4)). Such calculation reflects experimental reports saying that use of cosine enhances performance of retrieval. Use of cosine is equivalent to observation of an angle formed by both vectors, and norms of the vectors are ignored. Therefore, the similarity is enhanced as a calculated value approaches one. However, the vector space model requires calculations of similarities concerning all the documents. Therefore, in general, the vector space model is often applied after the retrieval object is subjected to restriction by the Boolean model.

$$\begin{matrix}[ Formula 4 ] & \\ δ ( {d}_{i} , {d}_{j} ) = \frac{{\sum }_{k = 1}^{M} {w}_{ik} {w}_{jk}}{\sqrt{{\sum }_{k = 1}^{M} {w}_{ik}^{2} \times {\sum }_{k = 1}^{M} {w}_{jk}^{2}}} & Formula ( 1.4 )\end{matrix}$$

### SUMMARY OF THE INVENTION

An object of the present invention is to provide an information retrieval system for offering information demanded by a user more accurately and plainly by utilizing a document database in the field of bioscience such as PubMed, for example.

In the present invention, in order to highly materialize a demand by a user, equipped are means for representing a screen for inputting query information, means for representing a query conception assembled by the inputted query information and means for enabling to edit the query conception, in the events of generation of a query, representation of retrieval results, feedback of the retrieval results to the query, and the like. Specifically, the present invention includes the following functions.

(1) A variety of formats is adoptable as a query.

(2) Progress during retrieval is represented, and a user is allowed to take an action with respect thereto.

(3) A variety of information can be extracted from retrieval results.

(4) A variety of feedback to a query is feasible based on retrieval results.

An information retrieval system or a server according to the present invention includes the following characteristics:

(1) An information retrieval system for retrieving information from a database, which includes: means for representing an input screen for inputting query information; and query vector representing means for representing a query conception assembled from the inputted query information as a query vector which contains a plurality of keywords and weights of the respective keywords.

(2) The information retrieval system according to (1), in which the query information can be inputted to the input screen with any one of a name of a file which saves information in a text format, a sentence and a phrase in a natural language, an ID number of a public database PubMed (http://www.ncbi.nlm.nih.gov/entrez/query.fcgi?db=PubMed), a URL, identification information of queries already registered, and a combination of any of the foregoing. Further, in the system, the query vector representing means represents the query vector generated by integrating the query information which is inputted to the input screen.

The ID number of a public database includes a UI number of the public database PubMed (http://www.ncbi.nlm.nih.gov/entrez/query.fcgi?db=PubMed), for example.

(3) The information retrieval system according to (1) which includes means for editing a query vector represented on the query vector representing means.

(4) The information retrieval system according to (3), in which the means for editing a query vector includes any one of: means for restricting keywords represented on the query vector representing means to keywords having at least a designated weight; and means for restricting keywords represented on the query vector representing means to keywords having high weights within a designated ranking.

(5) The information retrieval system according to (3), in which the means for editing a query vector includes means for individually modifying weights of keywords represented on the query vector representing means.

(6) The information retrieval system according to (1), which includes means for representing a table in which retrieved documents are disposed in a descending order of scores along one axis, a plurality of keywords that are elements of a query vector are disposed along another axis, and scores of the keywords in the respective documents are disposed on intersection points of the respective documents and the keywords.

(7) The information retrieval system according to (1), which includes: means for extracting terms co-occurring with the keywords in the query vector from documents obtained as retrieval results and representing a list of the terms; and means for adding a term designated among the terms represented on the list to the query information.

(8) The information retrieval system according to (1), which includes: retrieval result representing means for representing a list of retrieved documents in a descending order of score rankings; and means for adding a document designated among the documents represented on the retrieval result representing means to the query information.

(9) The information retrieval system according to (7), which includes means for re-assembling a query conception based on the modified query information and representing the re-assembled query conception as a query vector containing a plurality of keywords and weights of the respective keywords.

(10) A server which includes: means for generating a query vector containing a plurality of keywords and weights of the respective keywords out of query information transmitted from a client; means for transmitting a screen representing the query vector to the client; means for transmitting the query vector to a database for information retrieval; and means for transmitting a screen representing retrieval results from the database to the client.

(11) The server according to (10) which includes: means for extracting terms co-occurring with keywords in the query vector from documents obtained as the retrieval results; means for transmitting a screen which represents a list of the extracted terms; and means for re-assembling a query vector by adding a term to the query information, the term being designated by the client on the screen representing the list.

(12) The server according to (10) which includes: means for transmitting a retrieval result display screen representing a list of documents retrieved from the database in a descending order of score rankings; and means for re-assembling a query vector by adding a document to the query information, the document being designated by the client among the documents represented on the retrieval result display screen.

(13) A program for allowing a computer to realize the information retrieval system according to (1).

### BRIEF DESCIPTION OF THE DRAWINGS

FIG. 1 is a view showing a main screen for query formation, which is an initial screen of a retrieval system.

FIG. 2 is a view showing examples of a display screen of a query conception.

FIG. 3 is a view showing flow for confirmation of details of the query conception.

FIG. 4 is a view showing an aspect of keyword addition to the query concept.

FIG. 5 is a view showing retrieval results and details thereof.

FIG. 6 is a flowchart showing query expansion for a purpose of restriction.

FIG. 7 is a view showing display screens for document contents of the retrieval results.

FIG. 8 is a view showing flow for query recalculation.

FIG. 9 is a view showing a system configuration and an operation.

### DETAILED DESCRIPTION OF THE PREFERRED EMBODIMENT

Now, an embodiment of the present invention will be described in detail with reference to the accompanying drawings.

An information retrieval system of the present invention performs retrieval based on matching of an index term of a query with an index term in a document. Accordingly, when the index terms, which are originally identical, disaccord with each other owing to diversity of languages, documents to be retrieved become irretrievable. The diversity of languages includes diversity of word forms and diversity of word selection. Stemming is carried out for resolving a problem of diversification of word forms. Here, consideration will be made regarding the other diversity, i.e. diversity of word selection. The diversity of word selection refers to an aspect that a certain conception can be expressed with a variety of words. In order to solve this problem of the diversity of word selection, the following two modes have been conceived:

(1) to convert all kinds of expressions that represent the same conception into one identical symbol; and

(2) to substitute an expression contained in a query with a set of all expressions representing the conception identical to the expression in the query.

The mode (1) has an approach to degenerate all the words, which are ostensibly different but originally the same, into one identical symbol. It is a mode of converting words such as “road”, “street” and “way” into a symbol representing a conception such as “@ROAD”.

The mode (2) has an approach to expand one expression into all the expressions representing the conception identical thereto, similarly to perform stemming for treatment of the diversity of word forms. When a query contains a word “road”, then the word is substituted with a set of words such as “road”, “street” and “way” (Bruce R. Schatz, Eric H. Johnson, Pauline A. Cochrane: “Interactive Term Suggestion for Users of Digital Libraries: Using Subject Thesauri and Co-occurrence Lists for Information Retrieval”, Proceeding Digital Libraries '96: 1^{st} ACM International Conference on Research and Development in Digital Libraries, Mar. 20-23 1996 in Bethesda, Md.).

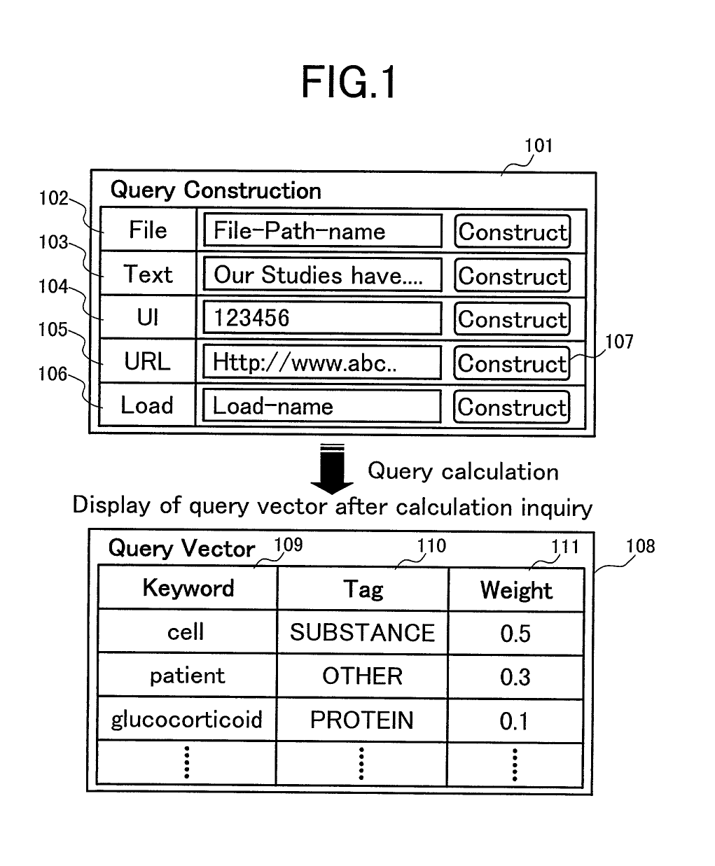

Here, description will be made first regarding a method of generating a query conception by use of FIG. 1. A screen 101 is a screen for generation of a query conception, which includes: a file name input form 102; a natural language input form 103; a UI number input form 104; a URL input form 105; a readout form 106 for query conceptions previously generated and saved; and execution buttons 107 for processing generation of query conceptions. When information already prepared as a file in a text format is inputted as query information, a file name of the file is inputted to the file name input form 102 by full path. Similarly, when a natural language is inputted as the query information, the natural language is described in the natural language input form 103. When a UI number being a Medline ID is inputted, the UI number is described in the UI number input form 104. When a certain page on the Internet is inputted, a URL is inputted to the URL input form 105. And in the case of inputting a query already registered, identification information of the registered query is described by use of the readout form 106.

After a series of operations, the execution buttons 107 for processing generation of query conceptions are pressed, whereby query conceptions for designated forms and an integrated query conception of the query conceptions of the designated forms are generated as query vectors. Here, the integrated query conception is produced by summation of the query vectors of the respective forms. When the query vectors are generated, a screen 108 is represented for indicating details of the query conception. In the screen, a reference numeral 109 denotes a list of keywords in the query vectors. A reference numeral 110 denotes a list of tags. Here, a tag refers to a classification that a keyword belongs to. For example, since a keyword “glucocorticoid” is a name of protein, a “PROTEIN” tag is allocated thereto. The screen 108 expresses and represents the query conception with the keywords on the list 109, the tags on the list 110 and weights on a list 111.

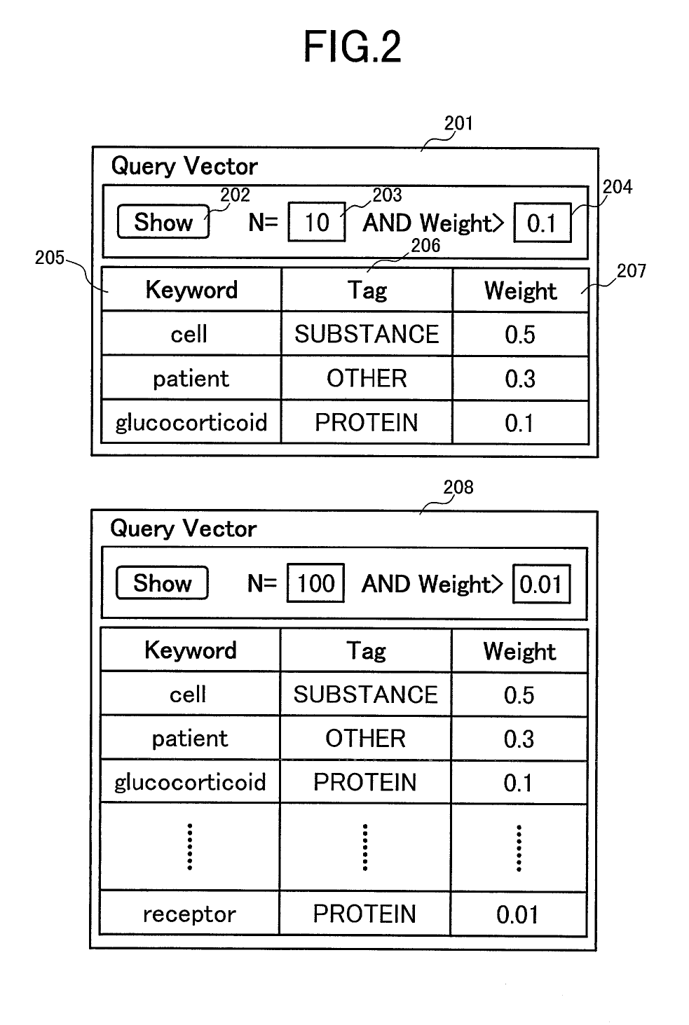

A screen 201 and a screen 208 in FIG. 2 show representation examples of the query conception, severally. In the screen 201, the keywords having weights of 0.1 or higher as well as within 10 highest values are solely represented. A condition as to how many cases to be represented starting the highest value is described by use of a case number input form 203, and a condition as to how high the weight of the keywords to be represented should at least be is described by use of a weight input form 204. After describing the case number input form 203 and the weight input form 204, a representation button 202 for updating representation is pressed, whereby only the keywords of the query conception that satisfy the above-described conditions are represented as a table. The table represents three factors of the keywords on a list 205, the tags on a list 206 and the weights on a list 207 as previously mentioned. In the screen 208, the keywords having weights of 0.01 or higher as well as within 100 highest weight values are solely represented. In this way, by using the case number input form 203, the weight input form 204 and the representation button 202, the details of the query conception can be confirmed.

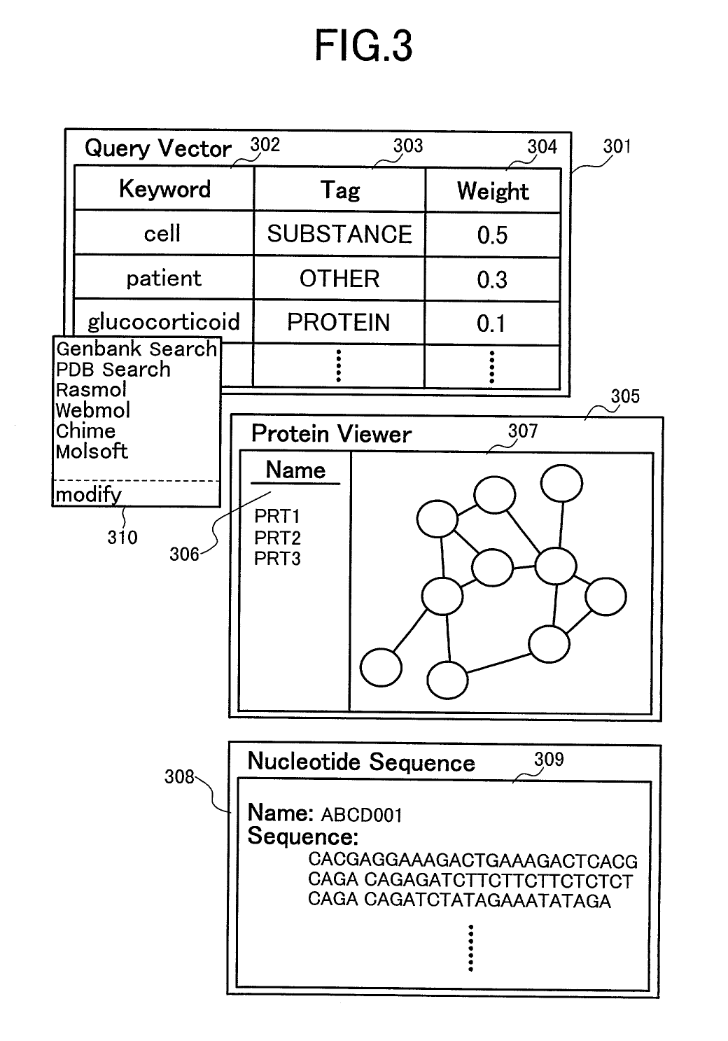

Next, description will be made regarding confirmation of the details of the query conception with reference to FIG. 3. A screen 301 is a display screen of the query conception. Here, the keywords on a list 302, the tags on a list 303 and the weights on a list 304 are arranged similarly to the previous description. Upon clicking a keyword among the keywords on the list 302 for requesting additional information in connection therewith in a state where the screen 301 is represented, a sub-window 310 is unfolded for effectuating retrieval of additional information on the selected keyword from an on-line database registered with the system in advance.

A screen 305 and a screen 308 represent results of retrieval from the database shown in the sub-window 310, which is unfolded in the event of clicking the keyword “glucocorticoid”. The screen 305 is a screen showing retrieval results of a database for proteins (the PDB), in which those enumerated on a list 306 are the retrieval results. A 3D-graphic image 307 shows a 3D-structure of the selected protein, which allows detailed confirmation of the selected protein by use of angular modification or scaling modification. Moreover, the screen 308 is a screen showing retrieval results of a database for sequences (the Genebank), in which a list 309 describes a name of the retrieved protein as well as a detailed sequence thereof.

Meanwhile, a screen for modifying the weight shows up in the event of clicking “modify” represented on the sub-window 310 and a new value is inputted thereto, which effectuates modification of a weight value of the keyword where the sub-window 310 is unfolded.

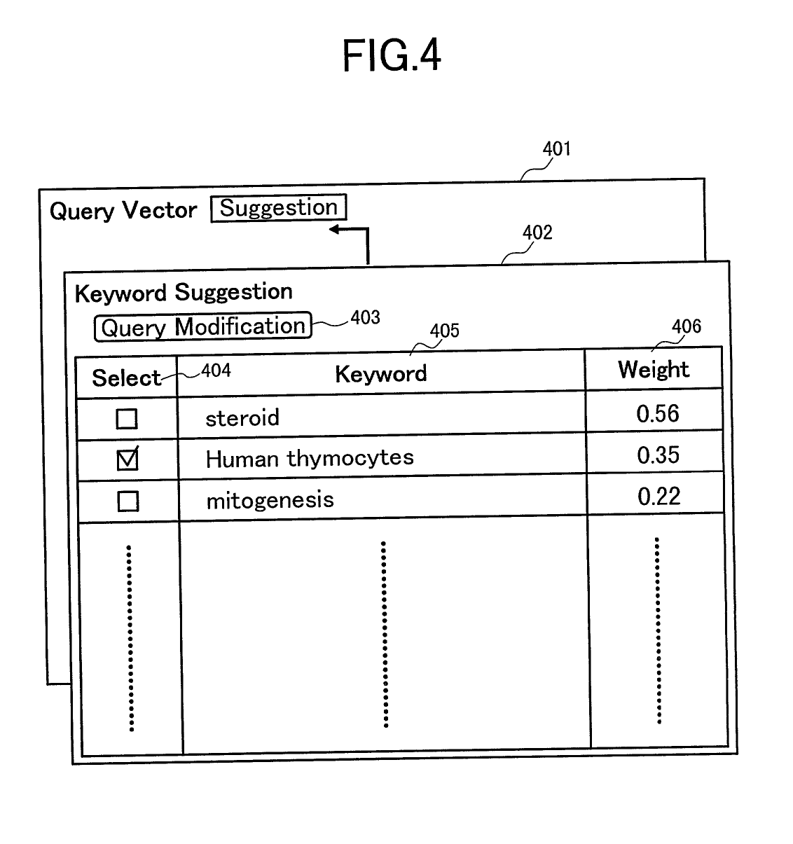

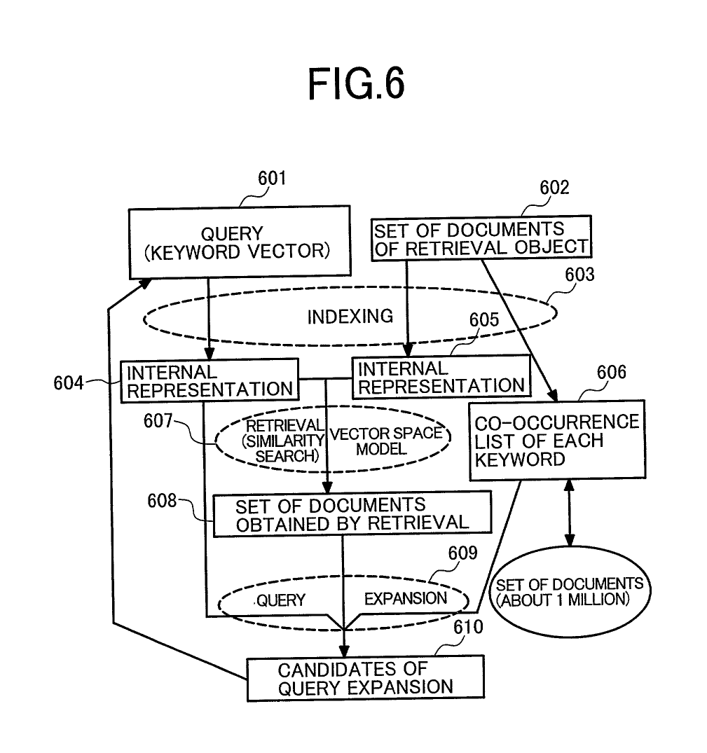

Next, description will be made regarding addition of keywords with reference to FIG. 4. A screen 401 is the above-described screen for producing the query conception. A screen 402 unfolded by clicking a “Suggestion” button 407 on the screen 401 is a display screen for submitting to a user a table of keyword candidates to be added to the query conception, the keyword candidates being predicted by analyzing documents. The screen 402 is the screen prepared for addition of keywords; accordingly, the user can add new keywords to the query conception by use of the screen 402. A button 403 is a decision button for keyword addition, and check buttons 404 are buttons for designating additional keywords to the query conception. Keywords on a list 405 are the predicted keywords, and a list 406 shows weights of those keywords. The keywords represented here are predicted by analyzing the documents, and are designed to reduce leakages in the retrieval results. Likewise, there is also a mode to represent the keywords suitable for restricting the retrieval results. Flow of a method of query expansion for such restriction is illustrated in FIG. 6.

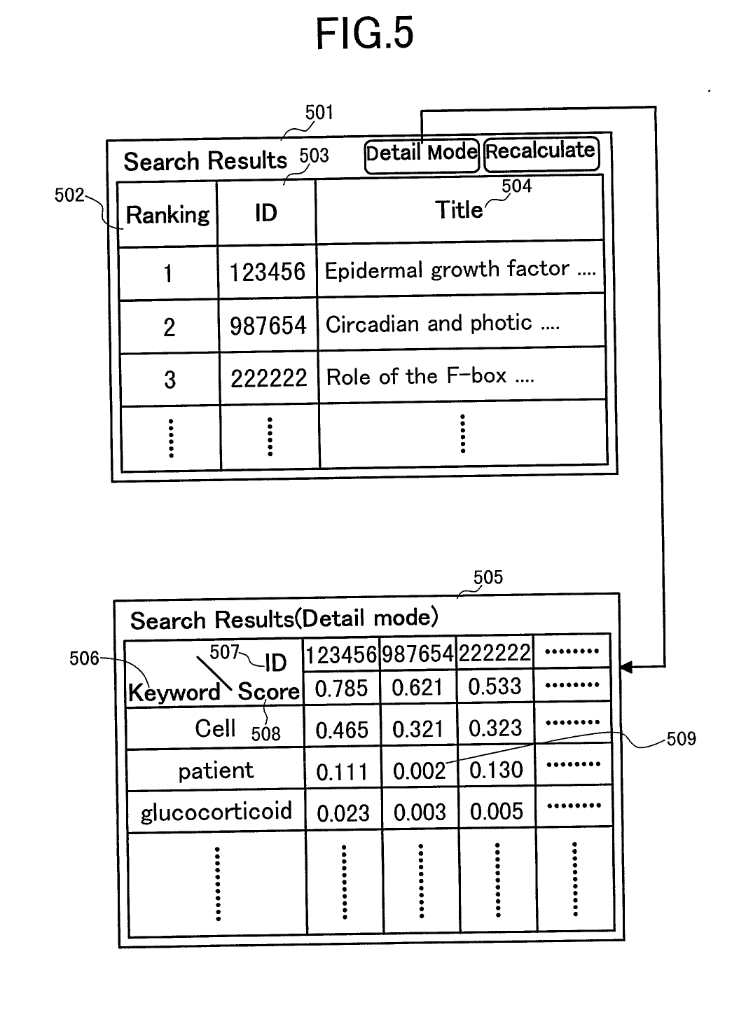

Next, description will be made regarding representation of retrieval results with reference to FIG. 5. A screen 501 is a display screen of normal retrieval results, and a screen 505 is a display screen of the retrieval results including more detailed information. When a “Detail Mode” button on the screen 501 is clicked, the screen 505 is unfolded for showing the detailed retrieval results.

The screen 501 represents the retrieval results using rankings on a list 502, document IDs on a list 503 and titles on a list 504. In the screen 505, by use of the document IDs on a transverse axis 507 and scores on a transverse axis 508, the documents are arranged along the direction of the transverse axis in descending order starting from the highest score in the retrieval results. And by use of the keywords on a longitudinal axis 506, it is feasible to confirm details as to how much each keyword influenced upon the retrieval. An element 509 represents a score showing how much a certain document indicated with a document ID on the transverse axis 507 is influenced by a certain keyword as indicated on the longitudinal axis 506.

FIG. 6 is a flowchart showing the method of query expansion for restriction. This method is different from a conventional query expansion. Conventionally, additional keywords are selected in order to supplement vulnerability of a query conception and to reduce leakages in retrieval results. On the contrary, in this method, keywords to be added to a query are selected for a purpose of restricting retrieval results in response to a state of immense retrieval results, in order to reduce the retrieval results to facilitate a discovery of a targeted document. In this method, indexing 603 is performed on a query 601 and on a set 602 of documents of retrieval object, thus obtaining an internal representation 604 of a query vector that is a query conception and an internal representation 605 of the retrieval objects. Simultaneously, a co-occurrence list of terms of the document is calculated with respect to each document in the set 602 of documents of retrieval object. Such a co-occurrence list individually calculated will be hereinafter referred to as an individual co-occurrence list 606. Subsequent to the processing as described above, comparison of vectors in accordance with a vector space model is carried out as retrieval 607. A consequence of the retrieval 607 is a set 608 of documents of retrieval results. Then, co-occurring terms are extracted from the individual co-occurrence lists 606 regarding the internal representation 604 of the query vector and the set 608 of documents of retrieval results, and thus prediction 609 of documents suitable for restriction is performed based on the co-occurring terms extracted. A consequence of the prediction 609 is candidates 610 of query expansion. Since this method uses extracted objects in response to the retrieval results, it is possible to extract surely restrictable terms.

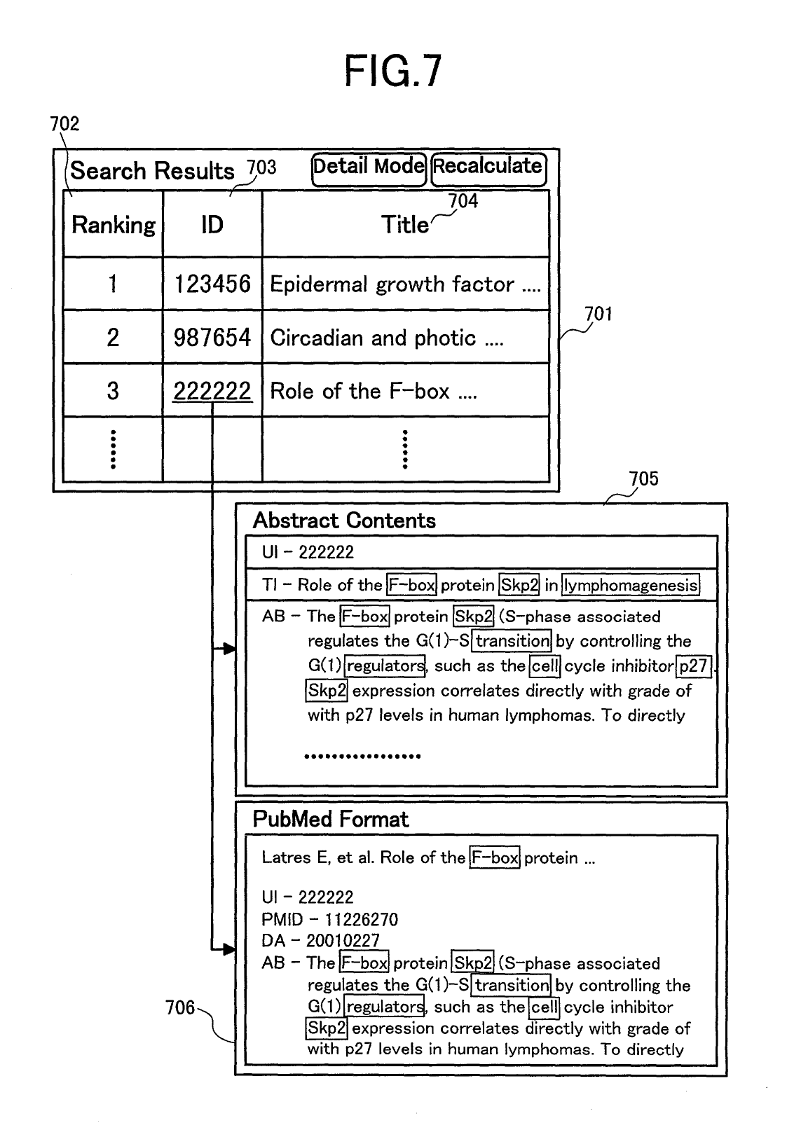

Next, description will be made regarding detail representation of retrieval results with reference to FIG. 7. A screen 701 is a display screen of retrieval results, in which the ranking on a list 702, the document IDs on a list 703 and the titles on a list 704 are arranged similarly to the previous description. On this screen, details concerning a certain document become visible by selection of the document ID of the document with a click of a mouse. A screen 705 and a screen 706 are examples of the details of the selected document. The screen 705 is an example of representation of the information stored locally in the system, in which the keywords used in the event of the retrieval are highlighted (the keywords are illustrated as framed letters in the drawing). Meanwhile, the screen 706 is an example of direct reference to an on-line document database registered with the system, in which highlighting of the keywords is added similarly to the foregoing in the event of representation thereof.

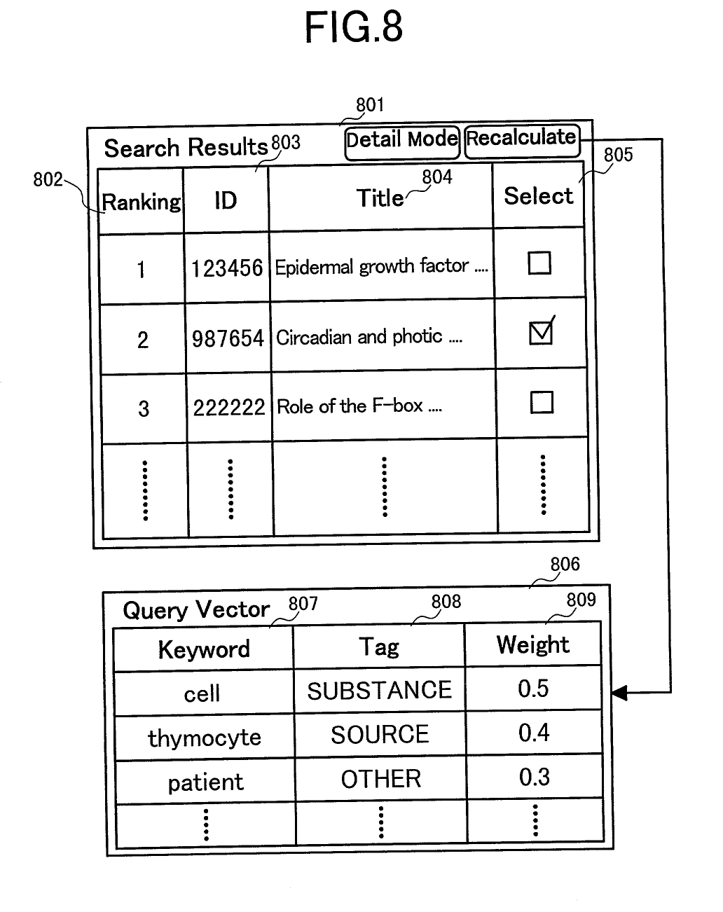

Next, description will be made regarding recalculation of a query with reference to FIG. 8. A screen 801 is a display screen of retrieval results, in which the rankings on a list 802, the document IDs on a list 803 and the titles on a list 804 are arranged similarly to the previous description. Check buttons 805 are provided for designation as to whether or not the relevant retrieval result is newly added to a query conception. By selecting documents to be added with the check buttons 805 and by clicking a “Recalculate” button with a mouse, a query conception (a query vector) can be re-assembled. A consequence of the re-assembly is illustrated in a screen 806. Representation on the screen 806 is similar to the above-described representation of the query conception. Accordingly, the keywords on a list 807, the tags on a list 808 and the weights on a list 809 are also arranged similarly to the foregoing.

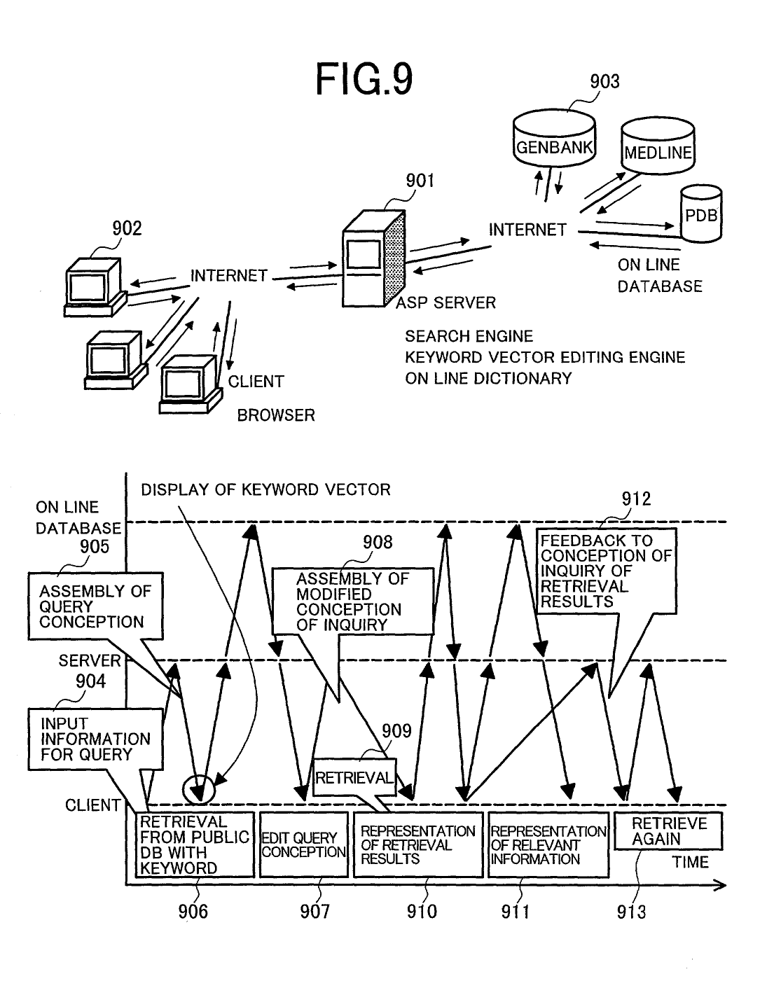

Next, description will be made regarding a system configuration and an operation with reference to FIG. 9. The configuration of the system includes a search engine, a query vector editing engine and an on-line dictionary disposed on a server 901, and a browser disposed on each of clients 902. A user has interaction with the server 901 via the Internet by using the browser on the client 902. Moreover, the server 901 accesses to on-line databases 903, which are registered with the system in advance, via the Internet if necessary. Functions of the server 901 can be realized by reading a program stored in a storage medium such as a CD-ROM, a DVD-ROM and an MO, or by reading a program via a network.

Regarding the operation, when information sources for a query such as keywords or texts are inputted at a client side as information input 904 for query, a server 901 side generates a query vector as assembly 905 of a query conception and sends a display screen to the client side. In response thereto, the client side confirms details of the query vector. In this event, keyword search is performed with respect to the registered databases, as retrieval 906 from public databases with keywords. The retrieval 906 is carried out by accessing the on-line databases via the server. In response to results from the on-line databases, the server side represents detail information thereof to the client side.

The client side further modifies tags or weights of the keywords as editing 907 of the query conception. The server side performs recalculation of a query vector as re-assembly 908 of a modified query conception. When the client side performs retrieval 909, the server side submits a display screen of results as representation 910 of retrieval results. In response thereto, the client side attempts retrieval of additional information from the registered databases, and obtains a display screen of relevant information as representation 911 of relevant information. Moreover, additional documents to the query conception can be selected from the retrieval results as feedback 912 to the query conception of retrieval results. In response thereto, re-retrieval 913 is lastly conducted by the user, whereby the feedback is realized. Steps on and after the re-retrieval 913 are basically similar to the retrieval 909 and so on.

According to the present invention, it is possible to designate a variety of demands as queries upon document retrieval from databases; simultaneously, it is possible to carry out feedback from documents of retrieval results by a variety of modes. Moreover, further retrieval from registered databases with retrieval results becomes feasible.

What is claimed is:

1. An information retrieval system for retrieving information from a database, said information retrieval system comprising:
means for representing an input screen for inputting query information; and
query vector representing means for representing a query conception assembled from the inputted query information as a query vector which contains a plurality of keywords and weights of the respective keywords.

2. The information retrieval system according to claim 1,
wherein the query information can be inputted to the input screen with any one of a name of a file which saves information in a text format, a sentence and a phrase in a natural language, an ID number of a public database, a URL, identification information of query conceptions already registered, and a combination of any of the foregoing, and
said query vector representing means represents the query vector generated by integrating the query information which is inputted to the input screen.

3. The information retrieval system according to claim 1, further comprising:
means for editing a query vector represented on said query vector representing means.

4. The information retrieval system according to claim 3,
wherein said means for editing a query vector includes any one of: means for restricting keywords represented on said query vector representing means to keywords having at least a designated weight; and means for restricting keywords represented on said query vector representing means to keywords having high weights within a designated ranking.

5. The information retrieval system according to claim 3,
wherein said means for editing a query vector includes means for individually modifying weights of keywords represented on said query vector representing means.

6. The information retrieval system according to claim 1, further comprising:
means for representing a table in which retrieved documents are disposed in a descending order of scores along one axis, a plurality of keywords that are elements of a query vector are disposed along another axis, and scores of the keywords in the respective documents are disposed on intersection points of the respective documents and the keywords.

7. The information retrieval system according to claim 1, further comprising:
means for extracting terms co-occurring with the keywords in the query vector from documents obtained as retrieval results and representing a list of the terms; and
means for adding a term designated among the terms on the list to the query information.

8. The information retrieval system according to claim 1, further comprising:
retrieval result representing means for representing a list of retrieved documents in a descending order of score rankings; and
means for adding a document designated among the documents represented on said retrieval result representing means to the query information.

9. The information retrieval system according to claim 7, further comprising:
means for re-assembling a query conception based on the modified query information and representing the re-assembled query conception as a query vector containing a plurality of keywords and weights of the respective keywords.

10. A server comprising:
means for generating a query vector containing a plurality of keywords and weights of the respective keywords out of query information transmitted from a client;
means for transmitting a screen representing the query vector to the client;
means for transmitting the query vector to a database for information retrieval; and
means for transmitting a screen representing retrieval results from the database to the client.

11. The server according to claim 10, further comprising:
means for extracting terms co-occurring with keywords in the query vector from documents obtained as the retrieval results;
means for transmitting a screen which represents a list of the extracted terms; and
means for re-assembling a query vector by adding a term to the query information, said term being designated by the client on the screen representing the list.

12. The server according to claim 10, further comprising:
means for transmitting a retrieval result display screen representing a list of documents retrieved from the database in a descending order of score rankings; and
means for re-assembling a query vector by adding a document to the query information, said document being designated by the client among the documents represented on the retrieval result display screen.

13. A program for allowing a computer to realize the information retrieval system according to claim 1.
